(19) United States
(12) Patent Application Publication
(10) Pub. No.: US 2026/0184516 A1
(43) Pub. Date: Jul. 2, 2026

(54) METHOD AND SINGULATOR FOR SINGULATING PIECES OF LUGGAGE

(71) Applicant: Siemens Logistics GmbH, Nürnberg (DE)

(72) Inventor: Christian Schwinge, Cadolzburg (DE)

(21) Appl. No.: 19/131,018

(22) PCT Filed: Oct. 18, 2023
(86) PCT No.: PCT/EP2023/078983

§ 371 Date: May 19, 2025

(30) Foreign Application Priority Data
Dec. 23, 2022 (EP) 22216501.1

(51) Int. Cl. B65G 47/53; B65G 47/68; B65G 47/70; B65G 47/71

(52) U.S. Cl. CPC B65G 47/53; B65G 47/682; B65G 47/70; B65G 47/71; B65G 2201/0264

(57) ABSTRACT

A method singulates articles, in particular pieces of luggage, with a singulator containing a feed section having a receiving portion and a segment portion, and a delivery section. The receiving portion leads into the segment portion. The segment portion leads transversely into the delivery section. The segment portion has at least two individually drivable segments that are arranged alongside one another and parallel to a feed direction of the segment portion and that each extend from the start to the end of the segment portion. The method includes the method steps of: a) filling the receiving portion with articles; b) transporting articles from the receiving portion to the segment portion; c) selecting a segment as a preferred segment; d) driving the preferred segment; e) transferring one or all of the articles resting on the preferred segment to the delivery section; and f) repeatedly carrying out method steps c to e.

The present invention relates to a method and a singulator for singulating piece goods, in particular pieces of luggage, according to the independent claims.

The present invention relates in particular to the transferring of piece goods, even more particularly pieces of luggage, from a Unitary Load Device ULD, inter alia, to a conveyor system. When a large container is unloaded by means of tilting, the pieces of luggage usually remain in an undefined position (next to each other and/or on top of each other and/or wedged together) on the conveyor belt.

In contrast to the technically developed singulating of piece goods available in postal/parcel applications, this function is not available in the airport environment. In the airport environment, large containers filled with pieces of luggage are usually unloaded by hand before the piece goods are sorted in a sorting system. However, for efficient sorting, singulating is required beforehand.

Having said this, in the airport sector too, the use of unloading aids and/or (semi-)automatic unloading apparatus which unload by means of tilting is becoming increasingly common, but the problem of singulating persists. Conventional singulating methods using conveyor belts arranged one behind the other and these being driven with velocity jumps solves the problem of wedging only inadequately, sporadically only in one direction and also requires a lot of space.

The object of the present invention is therefore to provide an improved method and an improved singulator for singulating piece goods, in particular pieces of luggage. This object is achieved by the solutions described in the independent claims.

This object is achieved by an apparatus and a method with the features of the main claims. Advantageous embodiments of the invention will emerge from the subclaims.

The solution according to the invention relates to a method for singulating piece goods, in particular pieces of luggage, with a singulator comprising a feed section having a receiving portion and a segment portion with a feed direction and a delivery section with a conveying direction. One end of the receiving portion leads into a start of the segment portion and is arranged on the same level or above the start of the segment portion. One end of the segment portion leads transversely or obliquely into the delivery section and is arranged at the same level or above the delivery section. The receiving portion is individually drivable and designed to receive a multiplicity of unsorted piece goods. The segment portion has at least two, in particular four, individually drivable segments which are arranged alongside one another and parallel to a feed direction of the segment portion and which each extend from the start to the end of the segment portion. The method comprises the method steps:
a) filling the receiving portions with a multiplicity of unsorted piece goods.
b) transporting piece goods on the receiving portion in the feed direction towards and onto the segment portion.
c) selecting a segment as a preferred segment.
d) preferably driving the preferred segment and not preferably driving the non-preferred segment.
e) transferring one or all of the piece goods resting on the preferred segment to the delivery section.
f) repeatedly carrying out the method steps c to e.

The solution according to the invention also relates to a singulator for singulating piece goods, in particular pieces of luggage, comprising a feed section having a receiving portion and a segment portion with a feed direction, a delivery section with a conveying direction. One end of the receiving portion leads into a start of the segment portion and is arranged at the same level or above the start of the segment portion. One end of the segment portion leads transversely or obliquely into the delivery section and is arranged at the same level or above the delivery section. The receiving portion is individually drivable and designed to receive a multiplicity of unsorted piece goods. The segment portion has at least two, in particular four, individually drivable segments which are arranged alongside one another and parallel to the feed direction of the segment portion and which each extend from the start to the end of the segment portion. The singulator comprises means for carrying out the method according to the invention.

The solution according to the invention also relates to a conveyor system comprising a singulator according to the invention.

The solution according to the invention can be further improved by various embodiments, each of which is advantageous in its own right and, unless specified otherwise, can be combined with one another as desired. These embodiments and the advantages associated with them are discussed hereinafter.

The solution according to the invention enables singulation with simple technical means in an uncomplicated manner. Advantageous embodiments of the invention will emerge from the subclaims.

According to one embodiment, an arrangement of the piece goods on the feed section, in particular on the segment portion, can be detected, it being possible to select the preferred segment as a function of the detected arrangement of the piece goods on the feed section, in particular on the segment portion.

According to a further embodiment, the means can have a detection unit for this purpose, it being possible for the detection unit to be arranged above the feed section, in particular above the segment portion, and designed to detect an arrangement of the piece goods on the feed section. According to a further embodiment, an activation of the receiving portion in the method step b) can be controlled as a function of the detected arrangement of the piece goods on the receiving portion of the feed section.

This prevents empty segments from being driven unnecessarily and enables a more efficient selection of the preferred segment. Nevertheless, singulation can also be achieved without detecting the arrangement of the piece goods.

According to a further embodiment, the preferred segment can be the segment on which piece goods rest right at the front downstream with regard to the conveying direction and/or the feed direction.

According to a further embodiment, in the method step c), the segment located furthest downstream with regard to the conveying direction can first be selected as the preferred segment. And after transferring one or all of the piece goods resting on the preferred segment to the delivery section in the method step e), the segment which is arranged directly adjacent to the previously preferred segment upstream with regard to the conveying direction can be newly selected as the preferred segment, and if no other segment is adjacent upstream, the segment arranged furthest downstream with regard to the conveying direction can be selected as the preferred segment. In this way, efficient singulating is achieved even without a known arrangement of the piece goods.

According to a further embodiment, the preferred drive can be is a sole or faster drive than the non-preferred drive if further piece goods are resting on adjacent segments at essentially the same level with regard to the feed direction or if the position of further piece goods is not known. And the non-preferred drive can be a stop and/or an equally fast and/or slower drive than the preferred drive. This ensures that a single item of piece goods, namely the item of piece goods resting (right at the front) on the preferentially driven segment, reaches the end of the segment portion first or right at the front. If an item of piece goods is resting on the preferred segment far upstream in the direction of flow and piece goods are resting on the non-preferred segments further upstream, singulating can be achieved even with equally fast preferred and non-preferred driving.

According to a further embodiment, two or more segments can be selected as the preferred segment and driven in the same way in the case of adjacent segments, and differently or in the same way in the case of non-adjacent segments. In this way, an item of piece goods resting on more than one segment due to its size or arrangement can be handled in exactly the same way as an item of piece goods resting on only one individual segment.

According to a further embodiment, the means may have a control unit, it being possible to design the control unit to control the means of conveyance of the receiving portion, the segment and the delivery section.

According to a further embodiment, the control unit can be designed to control the means of conveyance as a function of the piece goods detected by the detection units.

According to a further embodiment, the method can also comprise the method steps to create an unsorted pile of piece goods lying one above the other and to achieve rapid emptying of a large container in an uncomplicated manner: tilting of a large container filled with piece goods about a tilting axis, arranged transversely to the feed direction, at the start of the receiving portion onto the receiving portion and subsequent tilting back of the large container.

According to a further embodiment, the rotation or tilting of the receiving portion about the tilting axis can take place in such a manner that the end of the receiving portion is lifted and the receiving portion closes the large container and the receiving portion can then be turned back or tilted back together with the large container.

According to a further embodiment, the method may also comprise the method steps:
detecting a fill level of the large container after the tilting back of the large container.
repeated tilting and tilting back of the large container if there are still piece goods in the large container, otherwise removal or discharge of the large container and possible provision of a further large container filled with piece goods and repetition of the tilting cycle.

According to a further embodiment, the means may have a container detection unit, it being possible for the container detection unit to be arranged and designed to detect piece goods in a large container which can be tilted onto the receiving portion, in particular piece goods remaining in this is large container after tilting back. This container monitoring system can prevent piece goods from remaining in the large container (in the event of piece goods remaining in the large container, the tilting process can be repeated), otherwise the tilting process need not be repeated for an unnecessarily long time and if the large container is empty, the large container can be removed immediately and replaced with a new, filled large container.

According to a further embodiment, the delivery section may comprise two or more individually drivable sections arranged one behind the other with regard to the conveying direction and these sections can be operated with velocity jumps in order to set a distance between the singulated piece goods.

The method has, as far as transferable, the same advantages listed with regard to the singulator and the conveyor system.

The description of advantageous embodiments of the invention given so far contains numerous features, some of which are combined into several features in the individual subclaims. However, these features can also expediently be considered individually and combine to form useful further combinations. In particular, these features can be combined individually and in any suitable combination with the method according to the invention, the singulator according to the invention and the conveyor system according to the invention. Thus, method features are also to be regarded as properties of the corresponding apparatus unit formulated objectively and vice versa.

Embodiments of the invention are explained in more detail hereinafter with reference to the figures by way of example. The figures show:

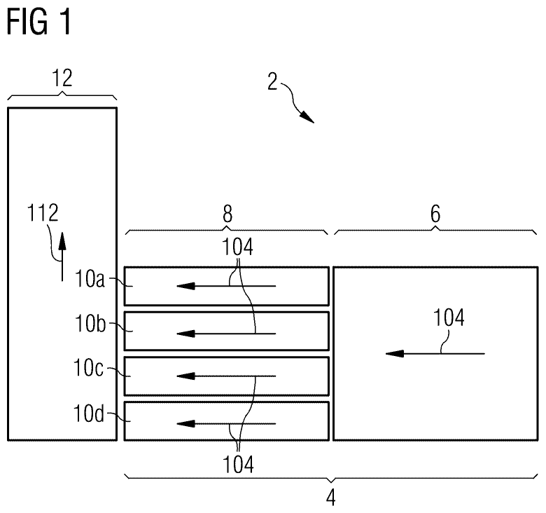

FIG. 1 A singulator according to the invention in top view;

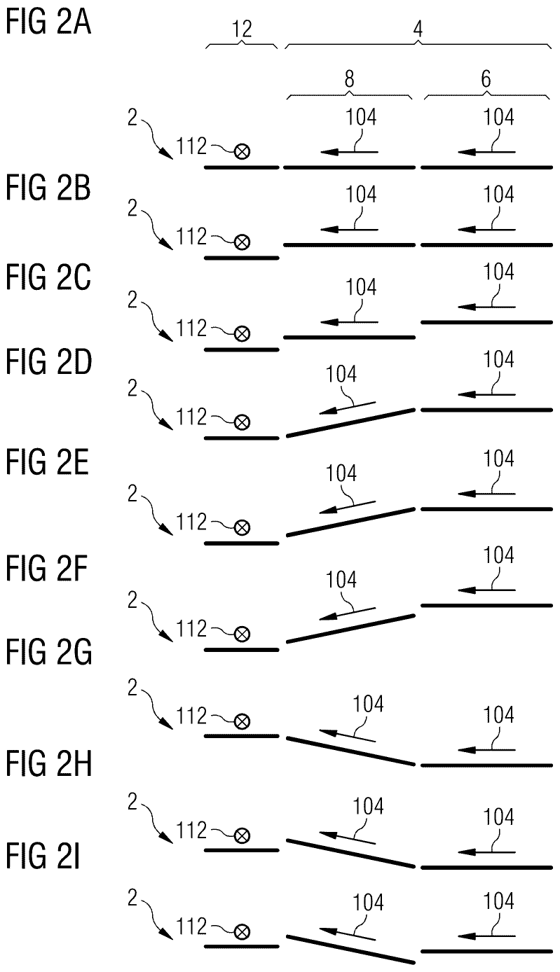

FIG. 2 Possible embodiments of the relative arrangement and inclination of the receiving portion, the segment portion and the delivery section, not exhaustive in the lateral section;

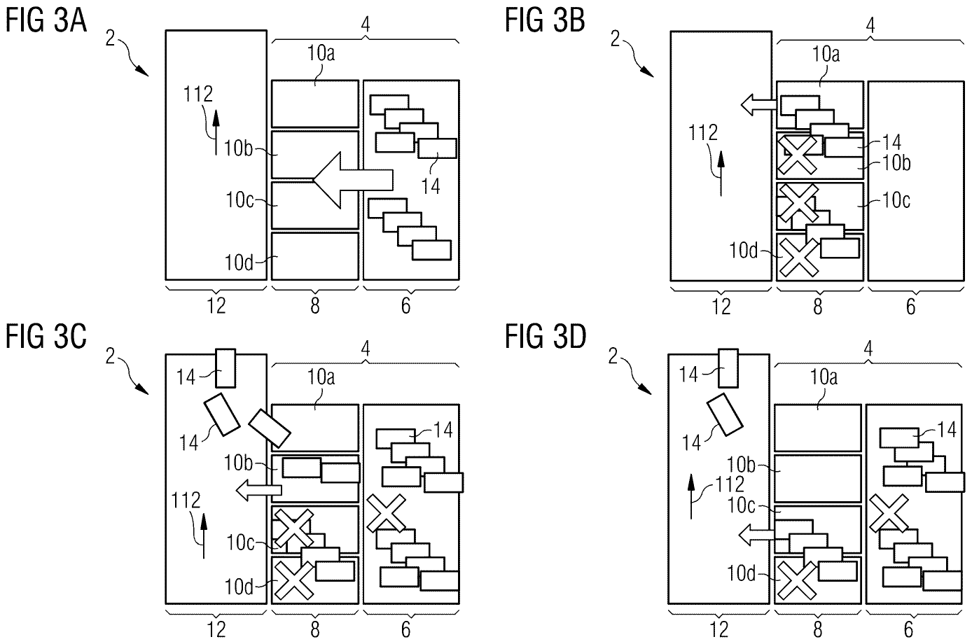

FIG. 3 A diagrammatic and top view of a sequential control of the segments of the segment portion of an embodiment of the singulator;

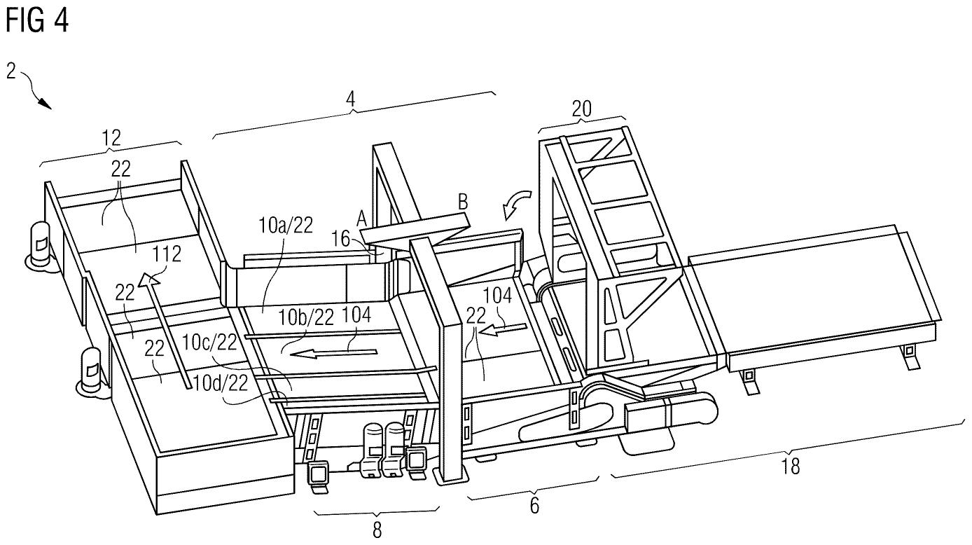

FIG. 4 An embodiment of the singulator according to the invention.

The following embodiments relate by way of example to pieces of luggage 14. However, the invention is not limited to pieces of luggage 14 but can be realized for a multiplicity of different piece goods 14. Thus, each of the described embodiments can not only be executed for pieces of luggage 14, but also for general piece goods 14.

The singulator 2 according to the invention of FIG. 1 has a feed section 4 with a receiving portion 6 with a controllable means of conveyance, e.g. a conveyor belt, and with a segment portion 8 with four individually drivable segments 10 which can be designed as conveyor belts or otherwise. Pieces of luggage 14 are conveyed along the feed direction 104 from the receiving portion 6 to the segment portion 8 and to the end of the segment portion 8, individually transferred to the delivery section 12 and there transported along the conveying direction 112. Singulation is achieved in particular by individual control of the segments 10 as well as an angle between the feed direction 104 and the conveying direction 112. According to one embodiment, the delivery section 12 may have several sections arranged one behind the other along the conveying direction 112 in order to set a distance between the separated pieces of luggage 14, for example, by means of velocity jumps in these sections.

One end of the receiving portion 6 leads into the start of the segment portion 8. The receiving portion 6 is loaded with pieces of luggage 14 in an unsorted manner, typically by emptying a large container, so that the pieces of luggage 14 can not only lie next to each other, but also on top of each other on the receiving portion 6. Singulation is achieved by preferred and non-preferred driving of the segments 10, so that at the end of the segment portion 8 the pieces of luggage 14 are transferred individually to the delivery section 12. The segments 10a, 10b, 10c, 10d are selected as preferred and non-preferred segments 10 either depending on the arrangement of the pieces of luggage 14 on the segment portion 8 (or in the case of greater advance planning and complexity of control, also depending on the arrangement of the pieces of luggage 14 on the receiving portion 6), the arrangement being detected by a detection unit 16 preferably arranged above the segment portion 8, or as sequential selection of the segments 10 as the preferred segment 10. The non-preferred segments 10 are preferably not driven. After the transfer of one or all of the pieces of luggage 14 resting on the preferred segment 10 from the segment portion 8 to the delivery section 12, a segment 10 is again selected as the preferred segment 10, preferably driven and the first (“preferred”) piece of luggage 14 resting on the preferred segment 10 with regard to the feed direction 104 or all pieces of luggage 14 resting on the preferred segment 10 are transferred to the delivery section. The method steps described are carried out until the receiving portion 6 is empty.

Preferred or non-preferred driving means driving the preferred or non-preferred segments 10 in such a manner that a piece of luggage 14 resting right at the front on the preferred segment 10 in the feed direction 104 is the first to be transferred to the delivery section 12. Thus, the preferred drive is a sole or faster drive than the non-preferred drive if further pieces of luggage 14 are resting on adjacent segments at essentially the same level with regard to the feed direction 104 or if the position of further pieces of luggage 14 is not known. If there are no other pieces of luggage 14 resting on the non-preferred segments 10 at the same level with regard to the feed direction 104, the non-preferred segments 10 can also be driven at the same speed as the preferred segment 10 to accelerate the method as in this case no piece of luggage 14 resting on the non-preferred segments 10 can overtake the piece or pieces of luggage 14 resting on the preferred segment 10. The non-preferred drive is therefore a stop and/or an equally fast and/or slower drive than the preferred drive. Different non-preferred segments 10 can be driven in different ways.

The aim of the method is for only singulated pieces of luggage 14 to rest on the delivery section 12.

When selecting the preferred segment 10 as a function of the arrangement of the pieces of luggage 14 according to an embodiment, the arrangement of the pieces of luggage 14 is is first detected by a detection unit 16. The segment 10 on which a piece of luggage 14 is resting right at the front downstream with regard to the feed direction 104 is selected as the preferred segment 10. This (“preferred”) piece of luggage 14 right at the front is now the first (“preferred”) piece of luggage 14 to be transferred to the delivery section by preferably driving the preferred segment 10. If two or more pieces of luggage 14 are positioned right at the front at the same level, according to one embodiment, the segment 10 on which a piece of luggage 14 is resting right at the front with regard to the conveying direction 112 is selected as the preferred segment. Depending on the width of the segment portion 8, more than one segment 10 can also be driven according to a further embodiment as the pieces of luggage 14 can still be transferred individually to the delivery section if the segment portion 8 is sufficiently wide.

After transferring the preferred piece of luggage 14 or all the pieces of luggage 14 resting on the preferred segment 10, the arrangement of the pieces of luggage 14 is again detected by a detection unit 16. Depending on the detected arrangement of the pieces of luggage 14, a further segment 10 is then selected as the preferred segment 10 in the same manner and the method steps described are carried out repeatedly.

When a segment is selected again as the preferred segment for transfer, the same or another segment can be selected as the preferred segment. When monitoring the receiving portion 6, it is also possible to determine and control the fill level of the receiving portion 6 at which pieces of luggage 14 are placed on the receiving portion 6 again.

FIG. 3 shows a sequential selection of the segments 104 as is the preferred segment 10. This procedure does not necessarily require detection of the arrangement of the pieces of luggage 14, but detection can nevertheless be helpful for accelerating the method: for example, a further segment 10 can be selected immediately as the preferred segment 10 if no piece of luggage 14 is resting on the initially preferred segment 10. A non-preferred segment 10 can also be driven at the same speed as the preferred segment 10 if a piece of luggage 14 is not resting on the latter until much further upstream with regard to the feed direction 104.

First, the receiving portion 6 is driven and the pieces of luggage 14 are conveyed onto the segment portion 8 (FIG. 3a). Subsequently, the segment 10a arranged at the front/furthest downstream with regard to the conveying direction 112 is selected as the preferred segment 10a, which is driven while the other segments 10b, 10c, 10d are not driven or are driven more slowly (FIG. 2b) until all the pieces of luggage 14 resting on the preferred segment 10a have been transferred to the driven delivery section 12. Thereafter, the segment 10b is newly selected as the preferred segment 10b, which is arranged upstream with regard to the conveying direction 112 downstream directly adjacent to the previously preferred segment 10a. All the pieces of luggage 14 resting on this now preferred segment 10b are transferred to the delivery section 12 by (preferred or sole) driving of this segment 10b (FIG. 3c). The same procedure is then carried out with the segment 10c (FIG. 3d) and subsequently with the segment 10d (not shown). In order to accelerate the method, the receiving portion 6 is again filled with pieces of luggage while the segments are being driven (FIGS. 3b and 3c), although this filling can also take place only after the segment portion 8 has been completely emptied. After the segment 10d arranged furthest downstream with regard to the conveying direction 112 has been selected as the preferred segment 10 (and thus no further segment 10 is adjacent upstream), the segment 10a arranged furthest downstream with regard to the conveying direction 112 is again selected as the preferred segment 10a. In the embodiment shown, the piece goods 14 are only transported from the receiving portion 6 to the segment portion 8 when no more piece goods 14 are resting on the segment portion 8.

FIG. 4 shows a singulator 2 according to a further embodiment. The delivery section 12 has several conveyor belts 22 arranged one behind the other along the conveying direction 112, which are driven with velocity jumps in order to set the distance between the singulated pieces of luggage 14. The receiving portion 6 is filled with the aid of a tilting apparatus 20 which is designed to receive a large container (not shown). The tilting apparatus 20 tilts the large container filled with pieces of luggage 14 about a tilting axis arranged at the start of the receiving portion 6, transversely to the feed direction 104, onto the receiving portion 6 and thus fills the receiving portion with pieces of luggage 14, the tilting apparatus 20 then tilts the large container back. According to a further embodiment, before the tilting of the tilting apparatus 20, the receiving portion 6 is essentially rotated about the tilting axis towards the tilting apparatus 20 and closes the large container. Subsequently, the receiving portion 6 and the tilting apparatus 20 together with the is large container are rotated about the tilting axis. Only the tilting apparatus and the large container are then tilted/rotated back. In this manner, pieces of luggage 14 are prevented from falling out sideways and are handled with care.

After the first tilting cycle, it is checked, typically with a container detection unit 16, whether pieces of luggage 14 have remained in the large container and the tilting process/cycle is repeated if pieces of luggage remain in the large container after tilting back. When the large container has been completely emptied, it is removed, typically by conveying out, and possibly replaced with another, filled large container. This can take place while the pieces of luggage 14 are being singulated.

FIG. 2 shows a non-exhaustive selection of possible embodiments of inclination and height offset of the receiving portion 6, the segment portion 8 and the delivery section 12, it being possible for these embodiments to be combined with all the other embodiments. Particularly preferred embodiments are shown in FIG. 2c, 2i, as here the offset between the sections 6, 8, 12 ensures that the pieces of luggage 14 can be transferred from one section to the next without tilting between the sections 6, 8, 12. The segment portion 8 along the conveying direction is designed to be horizontal or falling or rising. The embodiments with inclined segment portions 8 result in pieces of luggage 14 which are resting on one another sliding down and thus result in singulation in height. The embodiments with a segment portion 8 which rises along the feed direction are particularly advantageous as thus, the pieces of luggage only slide down in the direction of the receiving portion 6.

According to a further embodiment, two or more segments 10 are selected as the preferred segment 10 and are driven in the same way in the case of adjacent segments 10, and differently or in the same way in the case of non-adjacent segments 10. In this way, the singulator can also be used for larger pieces of luggage 14 which are resting on more than one segment 10.

According to one embodiment, the piece goods 14 lying in an undefined position on the conveyor belt 22 of the receiving portion 6 are first transported onto a special conveyor belt divided longitudinally into four parts 10a, 10b, 10c, 10d. Replenishment (from the receiving portion 6) is controlled by the filling quantity from the segment portion 8. The segment portion 8 is monitored by a camera 16 mounted above it. The camera 16 detects both the individual segments 10a, 10b, 10c, 10d of the conveyor belt 22, 8 as well as the piece goods 14 resting thereon. Depending on the occupancy, the individual segments 10a, 10b, 10c, 10d are now conveyed sequentially one after the other onto the (normal) discharge belt 12 positioned at 90°. It should be noted here that the order of the sequence is based on the conveying direction 112 of the discharge belt 12. The sequential removal of the piece goods 14 creates pre-separation and full separation is subsequently possible with simple velocity jumps. The camera system ensures that the sequence and belt speed are ideally suited to the current condition. The system independently optimizes the balance between performance (throughput) and process quality. A second camera looks into the large container (in the tilting apparatus 20) to assess whether any piece goods 14 remain after each tilting cycle. If this is not the case, the process is stopped and the container is removed. This drastically reduces the cycle time.

List of Reference Characters

| | |
|---|---|
| 2 | Singulator |
| 4 | Feed section |
| 6 | Receiving portion |
| 8 | Segment portion |
| 10 | Segment |
| 12 | Delivery section |
| 14 | Piece of luggage |
| 16 | Detection unit |
| 18 | Loading apparatus |
| 20 | Tipping apparatus |
| 22 | Conveyor belt/conveyor apparatus |
| 104 | Feed direction |
| 112 | Discharge direction |

1-15. (canceled)

16. A method for singulating piece goods with a singulator containing a receiving portion and a segment portion having a feed section with a feed direction and a delivery section with a conveying direction, wherein:
one end of the receiving portion leads into a start of the segment portion and is disposed at a same level or above the start of the segment portion;
one end of the segment portion leads transversely or obliquely into the delivery section and is disposed at a same level or above the delivery section;
the receiving portion is individually drivable and configured to receive a multiplicity of unsorted said piece goods; and
the segment portion has at least two individually drivable segments which are disposed alongside one another and parallel to the feed direction of the segment portion and each of the individually drivable segments extends from the start to an end of the segment portion;
the method comprises the following steps of:
a) filling the receiving portion with a plurality of the unsorted piece goods;
b) transporting the unsorted piece goods to the receiving portion in the feed direction towards and onto the segment portion;
c) selecting a segment of the individually drivable segments as a preferred segment;
d) driving the preferred segment and not driving a non-preferred segment of the individually drivable segments;
e) transferring at least one of the piece goods resting on the preferred segment to the delivery section; and
f) repeatedly carrying out the method steps c to e.

17. The method according to claim 16, which further comprises detecting an arrangement of the piece goods on the feed section, wherein selection of the preferred segment takes place in dependence on the arrangement of the piece goods on the feed section.

18. The method according to claim 17, wherein control of the receiving portion is regulated in the method step b) in dependence on the arrangement detected of the piece goods on the receiving portion of the feed section.

19. The method according to claim 16, wherein the preferred segment is the segment on which the piece goods rest right at a front downstream with regard to the conveying direction and/or the feed direction.

20. The method according to claim 16, wherein:
in the method step c), first selecting the segment disposed furthest downstream with regard to the conveying direction as the preferred segment; and
after transferring one or all of the piece goods resting on the preferred segment to the delivery section, in the method step e) another segment of of the individually drivable segments is newly selected as the preferred segment which is disposed immediately upstream of a previously preferred segment with regard to the conveying direction and if no further segment is adjacent upstream, the segment disposed furthest downstream with regard to the conveying direction is selected as the preferred segment.

21. The method according to claim 16, wherein:
a preferred drive of the individually drivable segments is a sole or faster drive than a non-preferred drive if further said piece goods are resting on adjacent segments essentially at a same level with regard to the feed direction or if a position of the further piece goods is not known; and
the non-preferred drive is at a stop and/or an equally fast and/or a slower drive than the preferred drive.

22. The method according to claim 16, which comprises tilting of a large container filled with the piece goods about a tilting axis disposed at a start of the receiving portion, transversely to the feed direction, onto the receiving portion and subsequent tilting back of the large container.

23. The method according to claim 22, which further comprises rotating the receiving portion about the tilting axis such that an end of the receiving portion is lifted and the receiving portion closes the large container and subsequent rotation of the receiving portion back together with the large container.

24. The method according to claim 22, which further comprises:
detecting a fill level of the large container after the tilting back of the large container; and
repeated the tilting and the tilting back of the large container, if any of the piece goods still remain in the large container, otherwise removal of the large container and a provision of a further large container filled with the piece goods.

25. The method according to claim 16, wherein:
the piece goods are pieces of luggage; and
the segment portion has at least four said individually drivable segments which are disposed alongside one another.

26. The method according to claim 16, which further comprises detecting an arrangement of the piece goods on the segment portion, wherein selection of the preferred segment takes place in dependence on the arrangement of the piece goods on the segment portion.

27. A singulator for singulating piece goods, the singulator comprising:
a feed section having a receiving portion and a segment portion with a feed direction;
a delivery section with a conveying direction;
one end of said receiving portion leads into a start of said segment portion and is disposed on a same level or above the start of said segment portion;
one end of said segment portion leads transversely or obliquely into said delivery section and is disposed at a same level or above said delivery section;
said receiving portion is individually drivable and is configured to receive a plurality of unsorted ones of the piece goods;
said segment portion has at least two individually drivable segments that are disposed alongside one another and parallel to the feed direction of said segment portion and a drivable segment of the individually drivable segments extending in each case from the start to an end of said segment portion; and
means for carrying out the method according to claim 16.

28. The singulator according to claim 27, wherein said means has a detector, wherein said detector is disposed above said feed section, and is configured to detect an arrangement of the piece goods on said feed section.

29. The singulator according to claim 27, wherein said means has a container detector, wherein said container detector is disposed and configured to detect the piece goods in a large container which can be tilted onto said receiving portion.

30. The singulator according to claim 27,
further comprising a means of conveyance of said receiving portion, said segments and said delivery section; and
wherein said means has a controller, said controller is configured to control said means of conveyance of said receiving portion, said segments and said delivery section.

31. The singulator according to claim 30, wherein:
said means has detectors; and
said controller is configured to control said means of conveyance depending on the piece goods detected by said detectors.

32. The singulator according to claim 27, wherein:
the singulator is configured for singulating pieces of luggage; and
said at least two individually drivable segments is two of four, individually drivable segments.

33. The singulator according to claim 28, wherein said detector is disposed above said segment portion.

34. The singulator according to claim 27, wherein said means has a container detector, wherein said container detector is disposed and configured to detect the piece goods in a large container which can be tilted onto said receiving portion and the piece goods remaining in the large container after tilting back.

35. A conveyor system, comprising:
said singulator according to claim 27.
